(19) United States
(12) Patent Application Publication
(10) Pub. No.: US 2004/0021764 A1
(43) Pub. Date: Feb. 5, 2004

(54) Visual teleconferencing apparatus

(75) Inventors: Edward C. Driscoll JR., Portola Valley, CA (US); John L. W. Furlan, Belmont, CA (US)

Correspondence Address: BEVER, HOFFMAN & HARMS, LLP, 1432 CONCANNON BLVD., BLDG. G, LIVERMORE, CA, 94550, US

(73) Assignee: Be Here Corporation, Pleasanton, CA

(21) Appl. No.: 10/336,244

(22) Filed: Jan. 3, 2003

Related U.S. Application Data
(60) Provisional application No. 60/352,779, filed on Jan. 28, 2002.

(51) Int. Cl. H04N 7/14

(52) U.S. Cl. 348/14.08

(57) ABSTRACT

An audio/visual conference station that includes a panoramic lens to capture an image of the panoramic scene surrounding the lens. The station also includes communication mechanisms to compress the panoramic image for transmission to a remote audio/visual conference station for display. Thus, people around the remote audio/visual conference station are able to both hear and see those at the local audio/visual conference station and vice versa. The audio/visual conference stations can also communicate through a server system to increase the number of visual conference stations exchanging or sharing images. In addition the server system can off-load some of the image processing steps from the visual conference stations.

This application claims the benefit of United States Provisional Patent Application serial number: 60/352,779 by Driscoll, filed Jan. 28, 2002.

### BACKGROUND OF THE INVENTION

1. Field of the Invention

This invention relates to the field of video conferencing.

2. Background

Video conferencing systems have been difficult to use and setup, and usually require special configurations and multiple cameras. In comparison, even high-quality audio conference telephones have a very small footprint and are simple to use.

A major problem with conventional (audio-only) teleconferencing systems is that it is difficult to determine who is on the other end of the line and who is speaking or interjecting words. Voices are identifiable only by their sound qualities (accent, pitch, inflection). In addition, the presence of completely silent parties cannot be determined or verified. Brief interjections can even complicate verbal identity determination because they are so short.

One reason for the slow adoption of video conferencing systems is that these systems are generally not very useful in a conference room setting. For example, a typical meeting includes a number of people, generally sitting around a table. Each of the people at the meeting can observe all of the other participants, facial expressions, secondary conversations etc. Much of this participation is lost using prior art video-conferencing systems.

One major problem with prior art videoconferencing systems is that they convert a meeting taking place over a table into a theatre event. That is, a meeting where everyone is facing a large television at the end of the room that has a distracting robotic camera on top of it. This is also true of the remote site where another “theatre” environment is set up. Thus, both the local and remote sites seem to be sitting on a stage looking out at the other audience. This arrangement inhibits and/or masks ordinary meeting behavior, where body language, brief rapid-fire verbal exchanges and other non-verbal behavior are critical. It also prevents the parties in each “theatre” from effectively meeting among their own local peers, because they are all forced to keep their attention at the television at the end of the room.

It would be advantageous to have a visual conferencing system that is simple to use, has only one lens, has a small footprint and can be positioned in the middle of a conference table.

### SUMMARY OF THE INVENTION

One aspect of the invention is a visual conference station that includes the facilities of the prior art teleconferencing devices along with a visual component. The lens of the visual component is mounted on the device. The lens captures a panoramic image of the surrounding scene. The captured image is compressed and sent over a network connection to a compatible remote visual conference station (possibly via a conference server) where the panoramic image is presented to the meeting participants at the remote location.

Other aspects include a device that communicates the visual information that cooperates with an existing audio teleconferencing station.

One aspect of the invention initializes the visual data communication link from information encoded over a telephone network.

Another aspect of the invention is a conference server system (and method and program product therefore) that receives visual information from one of the visual conference stations in a conference and distributes that information to other visual conference stations (optionally including the sourcing station).

The foregoing and many other aspects of the present invention will no doubt become obvious to those of ordinary skill in the art after having read the following detailed description of the preferred embodiments that are illustrated in the various drawing figures.

### DESCRIPTION OF THE DRAWINGS

FIG. 1A illustrates a side view of a visual conference station in accordance with a preferred embodiment;

FIG. 1B illustrates a top view of the visual conference station of FIG. 1A;

FIG. 2A illustrates a side view of the visual conference station of FIG. 1A in use in accordance with a preferred embodiment;

FIG. 2B illustrates a top view of FIG. 2A;

FIG. 3A illustrates the communications environment of the visual conference station in accordance with a preferred embodiment;

FIG. 3B illustrates the communications environment of the visual conference station in accordance with a preferred embodiment

FIG. 4 illustrates the visual conference station system architecture in accordance with a preferred embodiment;

FIG. 5 illustrates an initialization procedure in accordance with a preferred embodiment;

FIG. 6 illustrates a visual receive initialization procedure in accordance with a preferred embodiment;

FIG. 7 illustrates a visual send thread procedure in accordance with a preferred embodiment;

FIG. 8 illustrates a visual display thread procedure in accordance with a preferred embodiment;

FIG. 9A illustrates a conference registration process in accordance with a preferred embodiment; and

FIG. 9B illustrates a visual information distribution process in accordance with a preferred embodiment.

### DESCRIPTION OF THE PREFERRED EMBODIMENTS

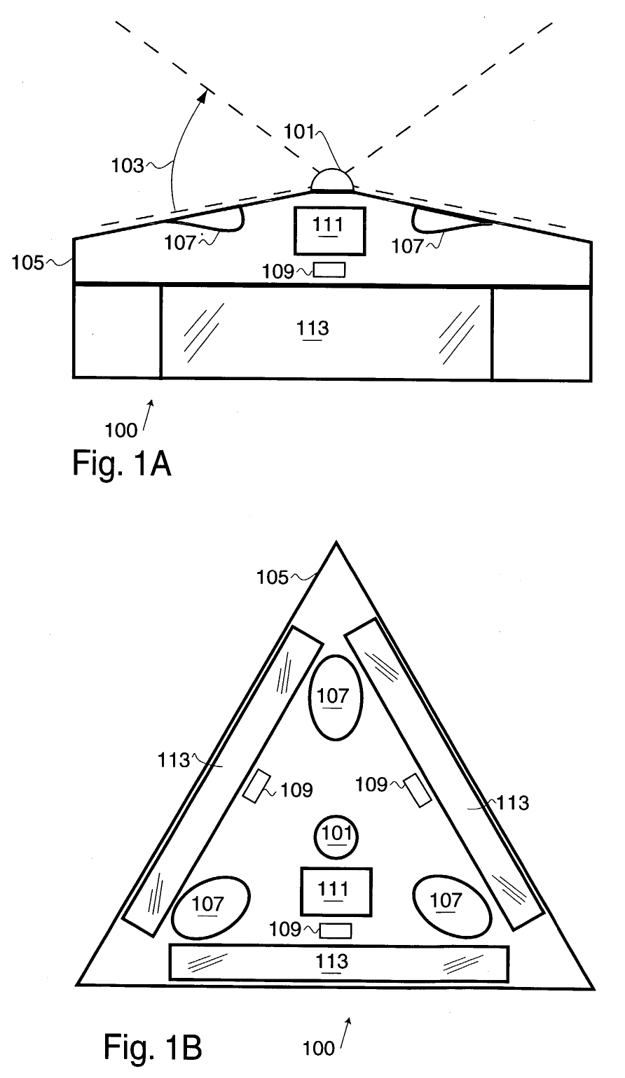

FIG. 1A illustrates a side view of a visual conference station 100 that includes a panoramic lens 101 that captures light from substantially 360-degrees around the axis of the lens and that has a vertical field-of-view 103 throughout. The panoramic lens 101 is mounted on the top of a housing 105. The housing 105 includes a speaker 107, a microphone 109, a control unit (keypad) 111, and a visual display 113.

The housing 105 is shaped and the panoramic lens 101 placed such that the housing 105 does not interfere with the field-of-view of the panoramic lens 101.

The speaker 107, microphone 109, and control unit (keypad) 111 have similar function to a traditional speakerphone.

One preferred embodiment uses the panoramic lens 101 (a micro-panoramic lens) such as disclosed in U.S. Pat. No. 6,175,454 by Hoogland and assigned to Be Here Corporation. Another preferred embodiment uses a panoramic lens such as disclosed in U.S. Pat. Nos. 6,341,044 or 6,373,642 by Driscoll and assigned to Be Here Corporation. These lenses generate annular images of the surrounding panoramic scene. However, other types of wide-angle lenses or combination of lenses can also be used (for example fish-eye lenses, 220-degree lenses, or other lenses that can gather light to illuminate a circle). A micro-panoramic lens provides benefits due to its small size. Although the subsequent description is primarily directed towards a panoramic lens that generates an annular image, the invention encompasses the use of wide-angle lenses (such as fish-eye lenses or very-wide angle lenses (for example a 220-degree wide-angle lens)).

Although not shown in the figure, the visual conference station 100 includes communication ports for connection to the telephone network and/or a high-speed communication network (for example, the Internet). In addition, the visual conference station 100 can include connections for separate speakers, microphones, displays, and/or computer input/output busses.

FIG. 1B illustrates a top view of the visual conference station 100 of FIG. 1A. Note that the visual display 113 is preferably tilted.

As is subsequently described, the panoramic lens 101 is optically connected to an optical sensor integrated circuit (such as a CCD or MOS device).

The visual display 113 can be a liquid crystal display, or any other display that can present a sequence of images (for example, but not limited to, cathode ray tubes and plasma displays).

Like a traditional high-quality conference phone, the visual conference station 100 is placed in the middle of a table around which the people participating in a conference. One visual conference station 100 communicates with another visual conference station 100 to exchange audio information acquired through the microphone 109 and panoramic image information captured by the panoramic lens 101. When received, the audio information is reproduced using the speaker 107 and the image information is presented using the visual display 113.

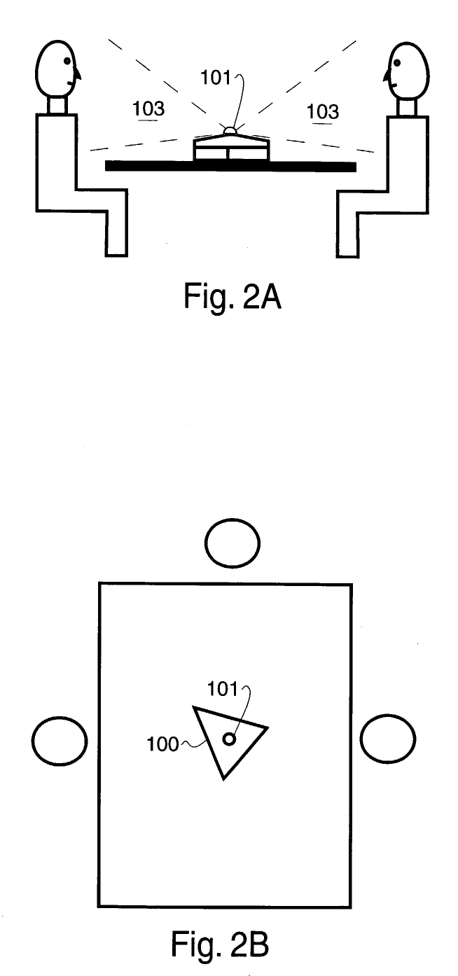

FIG. 2A illustrates a side view of the visual conference station 100 in use on a table with two shown people. Note that the vertical field-of-view 103 captures the head and torso or the meeting participants. In some embodiments, the vertical field-of-view 103 can be such that a portion of the table is also captured. FIG. 2B illustrates the placement of the visual conference station 100. Each of the people around the table is captured by the 360-degree view of the panoramic lens 101.

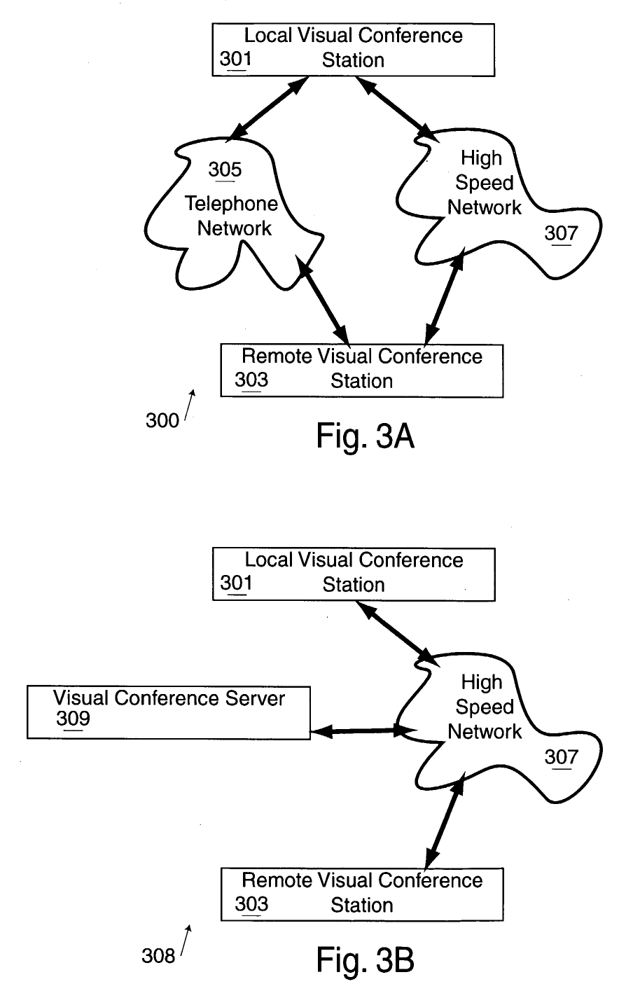

FIG. 3A illustrates a first communications environment 300 for a local visual conference station 301 and a remote visual conference station 303. In one preferred embodiment, the local visual conference station 301 and the remote visual conference station 303 communicate using both a telephone network 305 and a high-speed network 307. The telephone network 305 can be used to communicate audio information while the high-speed network 307 can be used to communicate visual information. In another preferred embodiment, both the visual and audio information is communicated over the high-speed network 307. In yet another preferred embodiment, both the visual and audio information is communicated over the telephone network 305. Thus, the conference participants at the one site can view the conference participants at the other site while the conference participants at the other site can also view the conference participants at the one site.

As is subsequently described the telephone network 305 can be used to send sufficient information from the local visual conference station 301 to the remote visual conference station 303 such that the remote visual conference station 303 can make a connection to the local visual conference station 301 using the high-speed network 307.

FIG. 3B illustrates a second communications environment 308 wherein the remote visual conference station 303 and the local visual conference station 301 communicate with a visual conferencing server 309 over a network. The visual conferencing server 309 connects a multiple of the visual conference station 100 together. The local visual conference station 301 sends its annular (or circular) image to the visual conferencing server 309. The visual conferencing server 309 then transforms the annular image into a panoramic image and supplies the panoramic image to the appropriate stations in the conference (such as at least one of the remote visual conference station 303 and/or the local visual conference station 301). Thus, the visual conferencing server 309 can offload the image processing computation from the stations to the visual conferencing server 309. The local visual conference station 301 also provides the visual conferencing server 309 with information about the characteristics of the sent image. This information can be sent with each image, with the image stream, and/or when the local visual conference station 301 registers with the visual conferencing server 309. Thus, the conference participants at the one site can view the conference participants at the other site while the conference participants at the other site can also view the conference participants at the one site.

Another capability of the system shown in FIG. 3B is that it allows one-way participation. That is, participants from the one site can be viewed by a multitude of other sites (the station at the one site sending audio/visual information to the server that redistributes the information to the remote visual conference station 303 at each of the other sites). This allows many observer sites to monitor a meeting at the one site.

One skilled in the art will understand that the network transmits information (such as data that defines a panoramic image as well as data that defines a computer program). Generally, the information is embodied within a carrier-wave. The term “carrier-wave” includes electromagnetic signals, visible or invisible light pulses, signals on a data bus, or signals transmitted over any wire, wireless, or optical fiber technology that allows information to be transmitted over a network. Programs and data are commonly read from both tangible physical media (such as a compact, floppy, or magnetic disk) and from a network. Thus, the network, like a tangible physical media, is a computer usable data carrier.

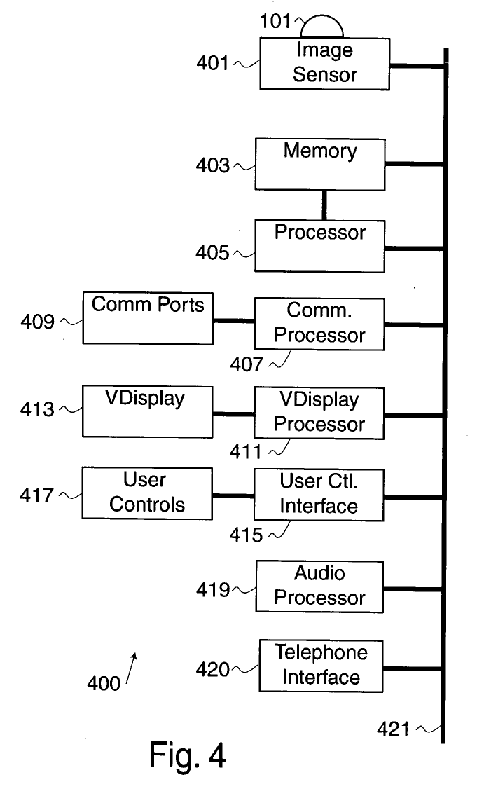

FIG. 4 illustrates a visual conference station system architecture 400 that includes an image sensor 401 on which the panoramic lens 101 is optically (and in a preferred embodiment also physically) attached. The panoramic lens 101 captures light from a 360-degree panoramic scene around the lens that is within the vertical field-of-view 103. This light from the panoramic scene is focused on the image sensor 401 where an annular or wide-angle image of the panoramic scene is captured. The image sensor 401 can be any of the commercially available image sensors (such as a CCD or CMOS sensor). The visual conference station system architecture 400 also includes a memory 403, a control processor 405, a communication processor 407, one or more communication ports 409, a visual display processor 411, a visual display 413, a user control interface 415, a user control input 417, an audio processor 419, a telephone line interface 420 and an electronic data bus system 421. One skilled in the art will understand that this architecture can be implemented on a single integrated circuit as well as by using multiple integrated circuits and/or a computer.

The panoramic lens can be a wide-angle lens or a catadioptric lens and in a preferred embodiment is a miniature lens. In a preferred embodiment, the field-of-view of the panoramic lens extends through the horizon line.

The memory 403 and the control processor 405 can communicate through the electronic data bus system 421 and/or through a specialized memory bus. The control processor 405 can be a general or special purpose programmed processor, an ASIC or other specialized circuitry, or some combination thereof.

The control processor 405 communicates to the image sensor 401 to cause a digitized representation of the captured panoramic image (the captured visual information) to be transferred to the memory 403. The control processor 405 can then cause all or part of the panoramic image to be transferred (via the communication processor 407 and the one or more communication ports 409 or the telephone line interface 420) and/or presented using the visual display processor 411 as conditioned by the user control input 417 through the user control interface 415.

In addition, a panoramic image can be received by the one or more communication ports 409 and/or the telephone line interface 420, stored in the memory 403 and presented using the visual display processor 411 and the visual display 413.

In one preferred embodiment of the visual conference station system architecture 400, the local visual conference station 301 and the remote visual conference station 303 directly exchange their respective panoramic images (either as an annular representation or as a rectangular representation) as well as the captured audio information.

In another preferred embodiment, the remote visual conference station 303 and the local visual conference station 301 communicate with the visual conferencing server 309 as previously discussed.

One skilled in the art would understand that although the visual conference station 100 illustrated in FIG. 1A incorporates the speaker 107, the microphone 109, and the visual display 113, other preferred embodiments need only provide interfaces to one or more of these devices such that the audio and visual information is provided to the audio/visual devices through wire, wireless, and/or optical means. Further, that the functions of the control unit (keypad) 111 can be provided by many different control mechanisms including (but not limited) to hand-held remote controls, network control programs (such as a browser), voice recognition controls and other control mechanisms. Furthermore, such a one would understand that the audio processor 419 typically is configured to include both an audio output processor used to drive a speaker and an audio input processor used to receive information from a microphone.

In yet another preferred embodiment, the video information from the image sensor 401 can be communicated to a computer (for example using a computer peripheral interface such as a SCSI, Firewire®, or USB interface). Thus, one preferred embodiment includes an assembly comprising the panoramic lens 101 and the image sensor 401 where the assembly is in communication with a computer system that provides the communication, audio/visual, user, and networking functionality.

In still another embodiment, the visual conference station 100 can include a general-purpose computer capable of being configured to send presentations and other information to the remote stations as well as providing the audio/visual functions previously described. Such a system can also include (or include an interface to) a video projector system.

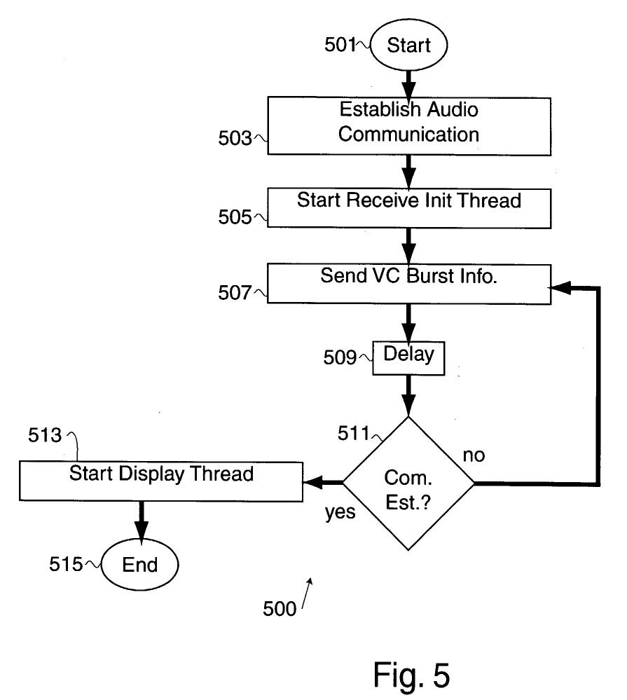

FIG. 5 illustrates an ‘initialization’ procedure 500 that can be invoked when the visual conference station 100 is directed to place a visual conference call. The ‘initialization’ procedure 500 initiates at a ‘start’ terminal 501 and continues to an ‘establish audio communication’ procedure 503 that receives operator input. The visual conference station 100 uses an operator input mechanism (for example, a keypad, a PDA, a web browser, etc.) to input the telephone number of the visual conference station 100 at the remote site. The ‘establish audio communication’ procedure 503 uses the operator input to make a connection with the remote visual conference station. This connection can be made over the traditional telephone network or can be established using network telephony.

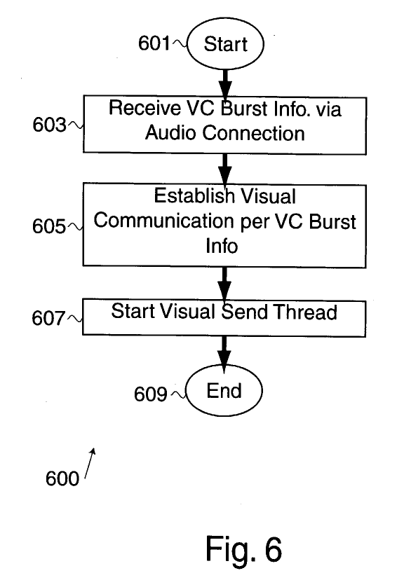

Once audio communication is established, the ‘initialization’ procedure 500 continues to a ‘start visual receive initialization thread’ procedure 505 that starts the visual receive initialization thread that is subsequently described with respect to FIG. 6.

Once audio communication is established, audio information can be exchanged between the stations over the telephone line or the high-speed link. Thus, captured audio information captured by a microphone at the local site is sent to the remote site where it is received as received audio information and reproduced through a speaker.

A ‘send visual communication burst information’ procedure 507 encodes the Internet address of the local visual conference station along with additional communication parameters (such as service requirements, encryption keys etc.) and, if desired, textual information such as the names of the people in attendance at the local visual conference station, and/or information that identifies the local visual conference station. Then a ‘delay’ procedure 509 waits for a period of time (usually 1-5 seconds). After the delay, a ‘visual communication established’ decision procedure 511 determines whether the remote visual conference station has established visual communication over a high-speed network with the local visual conference station. If the visual communication has not been established, the ‘initialization’ procedure 500 returns to the ‘send visual communication burst information’ procedure 507 to resend the visual communication information. Although not specifically shown in FIG. 5, if the visual communication is not established after some time period, this loop ends, and the visual conference station operates as a traditional audio conference phone.

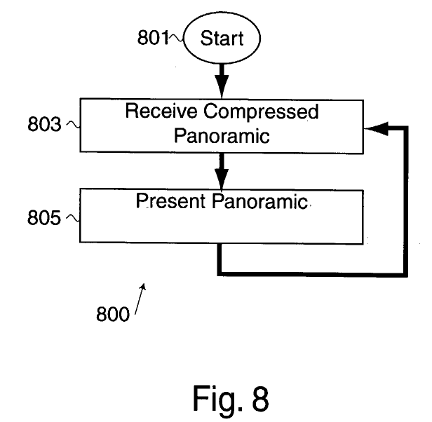

However, if the ‘visual communication established’ decision procedure 511 determines that visual communication has been established with the remote visual conference station, the ‘initialization’ procedure 500 continues to a ‘start display thread’ procedure 513 that initiates the display thread process as is subsequently described with respect to FIG. 8.

The ‘initialization’ procedure 500 exits at an ‘end’ terminal 515.

One skilled in the art will understand that there exist other protocols for establishing communication between the local visual conference station 301 and the remote visual conference station 303 other than the one just described. These other protocols will be useful in homogeneous networking environments where both audio and visual information are transmitted over the same network (for example, the internet or the telephone network).

FIG. 6 illustrates a visual receive initialization procedure 600 that is invoked by the ‘start visual receive initialization thread’ procedure 505 of FIG. 5 and that initiates at a ‘start’ terminal 601. The visual receive initialization procedure 600 waits at a ‘receive visual communication burst’ procedure 603 for receipt of the visual communication burst information sent by the other visual conference station. Once the visual communication burst information is received, it is parsed and the information made available as needed. An establish visual communication procedure 605 uses information received from the ‘receive visual communication burst’ procedure 603 to initiate communication of visual information with the visual conference station that sent the visual communication burst information. This establishment of communication between the visual conference stations can be accomplished by many protocols (such as by exchange of UDP packets or by establishment of a connection using an error correcting protocol and can use well-established Internet streaming protocols).

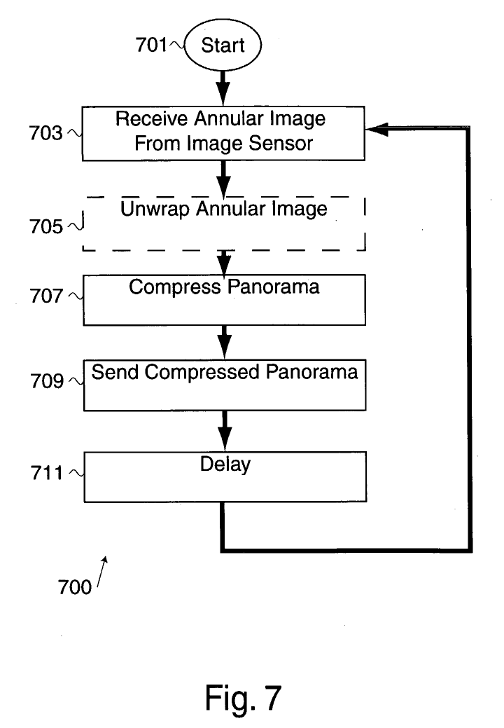

Once the visual communication between the visual conference stations is established, the visual receive initialization procedure 600 continues to a ‘start visual send thread’ procedure 607 that initiates the visual send thread that is subsequently described with respect to FIG. 7. Then the visual receive initialization procedure 600 completes through the ‘end’ terminal 609.

FIG. 7 illustrates a visual send thread 700 that initiates at a ‘start’ terminal 701 after being invoked by the ‘start visual send thread’ procedure 607 of FIG. 6. A ‘receive annular image’ procedure 703 reads the annular (or wide angle) image captured by the panoramic lens 101 from the image sensor 401 into the memory 403. Then an ‘unwrap annular image’ procedure 705 transforms the captured visual information (the annular or wide-angle image) into a panoramic image (generally, rectangular in shape). A ‘compress panoramic image’ procedure 707 then compresses the panoramic image or the captured visual information (either by itself, or with respect to previously compressed panoramic images). A ‘send compressed panoramic’ procedure 709 then sends the compressed visual information to the other visual conference station for display (as is subsequently described with respect to FIG. 8. A ‘delay’ procedure 711 then waits for a period. The visual send thread 700 returns to the ‘receive annular image’ procedure 703 and repeats until the visual portion of the conference call is terminated (for example, by ending the call, by explicit instruction by an operator etc.) In addition, an operator at the local visual conference station can pause the sending of visual images (for example, using a control analogous to a visual mute button).

The ‘unwrap annular image’ procedure 705 need not be performed (hence the dashed procedure box in FIG. 7) if this function is provided by a server (such as the visual conferencing server 309).

The ‘compress panoramic image’ procedure 707 can compress the panoramic image using MPEG compression, JPEG compression, JPEG compression with difference information or any techniques well known in the art to compress a stream of images. In addition, one skilled in the art will understand that the ‘unwrap annular image’ procedure 705 and the ‘compress panoramic image’ procedure 707 can be combined into a single step.

FIG. 8 illustrates a display thread 800 used to display the visual information sent by the ‘send compressed panoramic’ procedure 709 of FIG. 7. The display thread 800 is invoked by the ‘start display thread’ procedure 513 of FIG. 5 and initiates at a ‘start’ terminal 801. A ‘receive compressed panorama’ procedure 803 then receives the compressed panorama information (the received visual information) sent by the other visual conference station. Once the panorama information is received, the display thread 800 continues to a ‘present panorama’ procedure 805 that expands the compressed information and displays the resulting visual on the visual display 413.

One skilled in the art will understand that FIG. 5 through FIG. 8 describe aspects of the embodiment shown in FIG. 3A. Such a one would also understand how to adapt these aspects for the embodiment shown in FIG. 3B. One adaptation is that the local visual conference station 301 and the remote visual conference station 303 do not communicate directly but instead each communicates with the visual conferencing server 309. Another adaptation can be that neither the local visual conference station 301 nor the remote visual conference station 303 transform the annular or wide-angle image to a panoramic image. Instead, the annular or wide-angle image is compressed and sent to the visual conferencing server 309 where the image is decompressed and transformed into a panoramic image. The visual conferencing server 309 then compresses the panoramic image and sends it to the remote visual conference station 303 (or more than one remote station). Such a one will also understand how to automatically determine whether the local visual conference station 301 is connecting directly with the remote visual conference station 303 or to a visual conferencing server 309 and appropriately condition the procedures. Further, one skilled in the art after reading the forgoing will understand that the visual information exchanged between the visual conference stations can include computer-generated visual information (for example, a computer-generated presentation that generates images corresponding to that projected onto a screen).

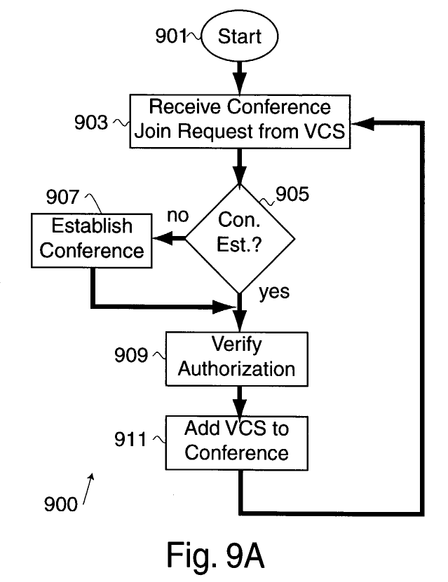

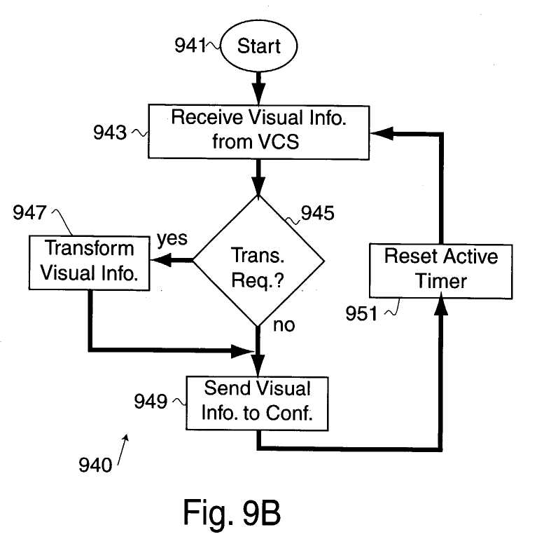

FIG. 9A illustrates a ‘conference registration’ process 900 that can be used by the visual conferencing server 309 to establish a conference. The ‘conference registration’ process 900 can be used with Internet, local area network, telephone or other protocols. The ‘conference registration’ process 900 initiates at a ‘start’ terminal 901 and continues to a ‘receive conference join request’ procedure 903 that receives and validates (verifies that the provided information is in the correct format) a request from a visual conference station to establish or join a conference. Generally, the information in the request includes a conference identifier and an authorization code (along with sufficient information needed to address the visual conference station making the request).

Next, a ‘conference established’ decision procedure 905 determines whether the provided information identifies an existing conference. If the identified conference is not already established, the ‘conference registration’ process 900 continues to an ‘establish conference’ procedure 907 that examines the previously validated join request and verifies that the visual conference station making the join request has the capability of establishing the conference. The ‘establish conference’ procedure 907 also determines the properties required for others to join the conference. One skilled in the art will understand that there are many ways that a conference can be established. These include, but are not limited to, the conference organizer including a list of authorized visual conference station addresses, providing a conference name and password, and other validation schemas known in the art. If this verification fails, the ‘conference registration’ process 900 processes the next join request (not shown).

Once the conference is established, or if the conference was already established, the ‘conference registration’ process 900 continues to a ‘verify authorization’ procedure 909 that examines the previously validated information in the join request to determine whether the visual conference station making the join request is authorized to join the identified conference. If this verification fails, the ‘conference registration’ process 900 processes the next join request (not shown).

If the join request is verified, the ‘conference registration’ process 900 continues to an ‘add VCS to conference’ procedure 911 that adds the visual conference station making the request to the conference. Then the ‘conference registration’ process 900 loops back to the ‘receive conference join request’ procedure 903 to handle the next join request.

One skilled in the art will understand that there are many ways, equivalent to the one illustrated in FIG. 9A, for establishing a conference.

FIG. 9B illustrates a ‘distribute visual information’ process 940 can be used to receive visual information from each visual conference station in the conference and to distribute the visual information to each of the member conference stations. The ‘distribute visual information’ process 940 can be used, without limitation, to receive the visual information from one member conference station and distribute that information to all the other member conference stations, or all the other member conference stations as well as the one member conference station; to exchange visual information between two member conference stations; and/or to exchange visual information between all member conference stations (subject to the amount of visual information that can be displayed, or operator parameters at a particular visual conference station).

The ‘distribute visual information’ process 940 initiates at a ‘start’ terminal 941 and continues to a ‘receive visual information from VCS’ procedure 943 that receives visual information from a visual conference station. The visual information is examined at a ‘transformation required’ decision procedure 945 to determine whether the visual information is in a rectangular panoramic form and need not be transformed. If the visual information is not in a rectangular panoramic form (thus, the server is to perform the transformation) the ‘distribute visual information’ process 940 continues to a ‘transform visual information’ procedure 947 provides the transformation from the annular or wide-angle format into a rectangular panoramic image and performs any required compression. Regardless of the branch taken at the ‘transformation required’ decision procedure 945, the ‘distribute visual information’ process 940 continues to a ‘send visual information to conference’ procedure 949 where the panoramic image is selectively sent to each of the member conference stations (possibly including the visual conference station that sent the visual information) based on the conference parameters.

The ‘distribute visual information’ process 940 then continues to a ‘reset active timer’ procedure 951 that resets a timeout timer. The timeout timer is used to detect when the conference is completed (that is, when no visual information is being sent to the visual conferencing server 309 for a particular conference). One skilled in the art will understand that there exist many other ways to detect when the conference terminates extending from explicit ‘leave’ commands to time constraints. After the timer is reset, the ‘distribute visual information’ process 940 loops back to the ‘receive visual information from VCS’ procedure 943 to receive the next visual information for distribution.

One skilled in the art after reading the forgoing will understand that visual information includes video information of any frame rate, sequences of still images, and computer generated images. In addition, such a one will understand that the described procedures can be implemented as computer programs executed by a computer, by specialized circuitry, or some combination thereof.

One skilled in the art after reading the forgoing will understand that there are many configurations of the invention. These include, but are not limited to:

A configuration where a device containing the visual processing portion of the invention is in communication with a standard speakerphone or audio conferencing device (through, for example, but without limitation, a phone line, an infrared communication mechanism or other a wireless communication mechanism). Thus, this configuration can be viewed as an enhancement to an existing audio conference phone.

A configuration where a separate computer reads the image sensor and provides the necessary visual information processing and communication.

A configuration where the visual conference station 100 includes wire or wireless connections for external computer/video monitors and/or computers (such that computer presentation at one conference station can be made available to each of the visual conference stations; and such that the panoramic image can be presented on projection monitors or on a personal computer in communication with the visual conference station.

A configuration where the visual conference station 100 includes a general-purpose computer.

From the foregoing, it will be appreciated that the invention has (without limitation) the following advantages:

It returns the “videoconference” format to the natural “people-around-a-table arrangement.” All of the participants at the remote site are now arrayed in front of the participants at the local site (in miniature). Thus, the peopled attending the conference look across the table at each other, and interact in a natural manner.

It is simpler and cheaper than the prior art videoconferencing systems. It also has a smaller, more acceptable footprint (equivalent to the ubiquitous teleconferencing phones in most meeting rooms).

It answers the basic question of most meetings: who is attending the meeting, who is speaking, and what the body language and other non-verbal cues are being made by the other participants.

Unlike the use of robotic cameras, it has no moving parts, makes no noise and thus does not distract the meeting participants.

It is completely automatic and thus, requires no manual or assisted steering, zooming or adjustment of the camera or lens.

It gracefully recovers from network problems in that it naturally degrades back to conventional teleconferencing, as opposed to having the meeting collapse because of a lost network connection.

It can use well-developed video streaming protocols when using IP network environments.

Although the present invention has been described in terms of the presently preferred embodiments, one skilled in the art will understand that various modifications and alterations may be made without departing from the scope of the invention. Accordingly, the scope of the invention is not to be limited to the particular invention embodiments discussed herein.

What is claimed is:

1. A visual conference station comprising:
a housing containing:
a control processor;
a memory coupled to said control processor;
a communications processor in communication with said control processor;
an audio output processor, in communication with said control processor, configured to prepare received audio information for presentation;
a display processor, in communication with said control processor, configured to prepare received visual information for presentation;
an audio input processor, in communication with said control processor, configured to prepare captured audio information captured near said housing for transmission;
an image sensor, in communication with said control processor, said control processor further configured to prepare captured visual information from said image sensor for transmission; and
a panoramic lens in optical communication with said image sensor and configured to capture a scene around the panoramic lens.

2. The visual conference station of claim 1 further comprising:
at least one visual display in communication with said display processor configured to present said received visual information;
at least one speaker in communication with said audio output processor; and
at least one microphone in communication with said audio input processor.

3. The visual conference station of claim 1 wherein said captured visual information is transmitted using said communications processor.

4. The visual conference station of claim 1 wherein said received visual information is received using said communications processor.

5. The visual conference station of claim 1 further comprising a telephone line interface and said received visual information is received using said telephone line interface.

6. The visual conference station of claim 1 wherein said control processor is configured to transform said captured visual information into a rectangular panoramic image prior to transmission.

7. The visual conference station of claim 1 wherein the panoramic lens is a wide-angle lens.

8. The visual conference station of claim 1 wherein the panoramic lens is a catadioptric lens.

9. The visual conference station of claim 1 wherein the panoramic lens has a field-of-view that extends through a horizon line.

10. The visual conference station of claim 1 wherein the panoramic lens is mounted on the housing.

11. The visual conference station of claim 1 wherein said received visual information has been sent from a second visual conference station.

12. The visual conference station of claim 1 wherein said received visual information has been sent from a visual conference server.

13. A method comprising steps of:
receiving visual information from a first visual conference station;
identifying a conference to which said first visual conference station belongs;
identifying a second visual conference station in said conference; and
distributing said visual information to said second visual conference station.

14. The method of claim 13 further comprising transforming said visual information from a non-rectangular image into a panoramic image for distribution.

15. The method of claim 14 further comprising distributing said panoramic image to said first visual conference station.

16. The method of claim 13 further comprising steps of:
establishing said conference responsive to one of said first visual conference station and said second visual conference station;
maintaining said conference; and
terminating said conference.

17. The method of claim 13 further comprising steps of:
receiving audio information from said first visual conference station; and
distributing said audio information to said second visual conference station.

18. A visual conference server comprising:
a receiving mechanism configured to receive visual information from a first visual conference station;
a first identification mechanism configured to identify a conference to which said first visual conference station belongs;
a second identification mechanism, responsive to the first identification mechanism, configured to identify a second visual conference station in said conference; and
a distribution mechanism, responsive to the second identification mechanism, configured to distribute said visual information to said second visual conference station.

19. The visual conference server of claim 18 further comprising a transformation mechanism, responsive to the receiving mechanism, configured to transform said visual information from a non-rectangular image into a panoramic image for distribution.

20. The visual conference server of claim 19 wherein the distribution mechanism is further configured to distribute said panoramic image to said first visual conference station.

21. The visual conference server of claim 18 further comprising:
a conference initiation mechanism configured to establish said conference responsive to one of said first visual conference station and said second visual conference station;
a conference maintenance mechanism configured to maintain said conference; and
a conference termination mechanism configured to terminate said conference.

22. The visual conference server of claim 18 further comprising:
an audio reception mechanism configured to receive audio information from said first visual conference station; and
an audio distribution mechanism, responsive to the audio reception mechanism, configured to distribute said audio information to said second visual conference station.

23. A computer program product comprising:
a computer usable data carrier having computer readable code embodied therein for causing a computer to operate as a visual conference server, said computer readable code including:
computer readable program code configured to cause said computer to effect a receiving mechanism configured to receive visual information from a first visual conference station;
computer readable program code configured to cause said computer to effect a first identification mechanism configured to identify a conference to which said first visual conference station belongs;
a second identification mechanism, responsive to the first identification mechanism, configured to identify a second visual conference station in said conference; and
computer readable program code configured to cause said computer to effect a distribution mechanism, responsive to the second identification mechanism, configured to distribute said visual information to said second visual conference station.

24. The computer program product of claim 23 further comprising computer readable program code configured to cause said computer to effect a transformation mechanism, responsive to the receiving mechanism, configured to transform said visual information from a non-rectangular image into a panoramic image for distribution.

25. The computer program product of claim 24 wherein the distribution mechanism is further configured to distribute said panoramic image to said first visual conference station.

26. The computer program product of claim 23 further comprising:
computer readable program code configured to cause said computer to effect a conference initiation mechanism configured to establish said conference responsive to one of said first visual conference station and said second visual conference station;
computer readable program code configured to cause said computer to effect a conference maintenance mechanism configured to maintain said conference; and
computer readable program code configured to cause said computer to effect a conference termination mechanism configured to terminate said conference.

27. The computer program product of claim 23 further comprising:
computer readable program code configured to cause said computer to effect an audio reception mechanism configured to receive audio information from said first visual conference station; and
a computer readable program code configured to cause said computer to effect n audio distribution mechanism, responsive to the audio reception mechanism, configured to distribute said audio information to said second visual conference station.
